(19) United States
(12) Patent Application Publication
(10) Pub. No.: US 2014/0071160 A1
(43) Pub. Date: Mar. 13, 2014

(54) ELECTRONIC APPARATUS AND DISPLAY CONTROL METHOD

(71) Applicant: Kabushiki Kaisha Toshiba, Tokyo (JP)

(72) Inventors: Motonobu SUGIURA, Ome-shi (JP); Kohji SAIKI, Kawasaki-shi (JP); Yuuji IRIMOTO, Fussa-shi (JP)

(73) Assignee: Kabushiki Kaisha Toshiba, Tokyo (JP)

(21) Appl. No.: 13/969,113

(22) Filed: Aug. 16, 2013

Related U.S. Application Data
(63) Continuation of application No. PCT/JP2013/058206, filed on Mar. 14, 2013.

(30) Foreign Application Priority Data
Sep. 7, 2012 (JP) 2012-197889

(51) Int. Cl. G06T 1/00

(52) U.S. Cl. CPC G06T 1/00
USPC 345/619

(57) ABSTRACT

According to one embodiment, an electronic apparatus includes a processor and a display processor. The processor acquires a plurality of first contents associated with a first period, and a plurality of second contents associated with a second period different from the first period. The display processor displays on a screen a first object representing a set of the plurality of first contents and a second object representing a set of the plurality of second contents on the screen in accordance with the first period and the second period. The first object and the second object are arranged in one direction on the screen in a chronological order.

### CROSS REFERENCE TO RELATED APPLICATIONS

This application is a Continuation application of PCT Application No. PCT/JP2013/058206, filed Mar. 14, 2013 and based upon and claiming the benefit of priority from Japanese Patent Application No. 2012-197889, filed Sep. 7, 2012, the entire contents of all of which are incorporated herein by reference.

### FIELD

Embodiments described herein relate generally to a content display control method.

### BACKGROUND

In recent years, various electronic apparatuses such as a tablet PC and personal computer (PC) have been developed. Most of electronic apparatuses of this type can import a content such as a photo from an external apparatus, and can save it in electronic apparatuses.

An electronic apparatus can display the saved content on a screen of a display. Also, the electronic apparatus can exchange a content with an on line storage site via the Internet and the like. Furthermore, the electronic apparatus can transmit (upload) a content to an SNS (Social Network Service) site, and can receive a comment or the like for the uploaded content from the SNS site.

However, when a large number of contents are saved in the electronic apparatus, the user has to make an operation for finding out a desired content from these large number of contents. Each of the large number of contents is associated with a wide variety of information such as a location of that content and date of acquisition of that content, and the like. For this reason, the large number of contents can be sorted out using the wide variety of information, but the user has to make complicated operations to sort out the large number of contents. Also, realization of a novel function required to easily find out a content has been demanded.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to one embodiment.

FIG. 2 is an exemplary view showing an example of the overall configuration of a network to which the electronic apparatus according to the embodiment is connected.

FIG. 3 is an exemplary block diagram showing an example of the system configuration of the electronic apparatus according to the embodiment.

FIG. 4 is an exemplary block diagram showing a content playback application program executed by the electronic apparatus according to the embodiment.

FIG. 5 is an exemplary flowchart showing the sequence of import processing of the content playback application program executed by the electronic apparatus according to the embodiment.

FIG. 6 is an exemplary flowchart showing the sequence of processing of a timeline display screen of the content playback application program executed by the electronic apparatus according to the embodiment.

FIG. 7 is an exemplary flowchart showing the detailed processing sequence of the timeline display screen of the content playback application program executed by the electronic apparatus according to the embodiment.

FIG. 8 is an exemplary flowchart showing another detailed processing sequence of the timeline display screen of the content playback application program executed by the electronic apparatus according to the embodiment.

FIG. 9 is an exemplary view showing an example of the timeline display screen of the content playback application program executed by the electronic apparatus according to the embodiment.

FIG. 10 is an exemplary view showing an example of a thumbnail list display screen of the content playback application program executed by the electronic apparatus according to the embodiment.

FIG. 11 is an exemplary view showing an example of a full display screen of the content playback application program executed by the electronic apparatus according to the embodiment.

FIG. 12 is an exemplary view showing an example of a user album on the timeline display screen of the content playback application program executed by the electronic apparatus according to the embodiment.

FIG. 13 is an exemplary view showing an example of a date album on the timeline display screen of the content playback application program executed by the electronic apparatus according to the embodiment.

FIG. 14 is an exemplary view showing an example of an SNS album on the timeline display screen of the content playback application program executed by the electronic apparatus according to the embodiment.

FIG. 15 is an exemplary view showing an example of a slideshow of the content playback application program executed by the electronic apparatus according to the embodiment.

FIG. 16 is an exemplary view showing an example of a detailed information screen of the SNS album of the content playback application program executed by the electronic apparatus according to the embodiment.

FIG. 17 is an exemplary view showing an example of a screen which displays detailed information of a content displayed by the content playback application program executed by the electronic apparatus according to the embodiment.

FIG. 18 is an exemplary view showing an example of a content import screen of the content playback application program executed by the electronic apparatus according to the embodiment.

FIG. 19 is an exemplary view showing an example of a content index information database table used by the electronic apparatus according to the embodiment.

### DETAILED DESCRIPTION

Various embodiments will be described hereinafter with reference to the accompanying drawings.

In general, according to one embodiment, an electronic apparatus includes a processor and a display processor. The processor acquires a plurality of first contents associated with a first period, and a plurality of second contents associated with a second period different from the first period. The display processor displays on a screen a first object representing a set of the plurality of first contents and a second object representing a set of the plurality of second contents on the screen in accordance with the first period and the second period. The first object and the second object are arranged in one direction on the screen in a chronological order.

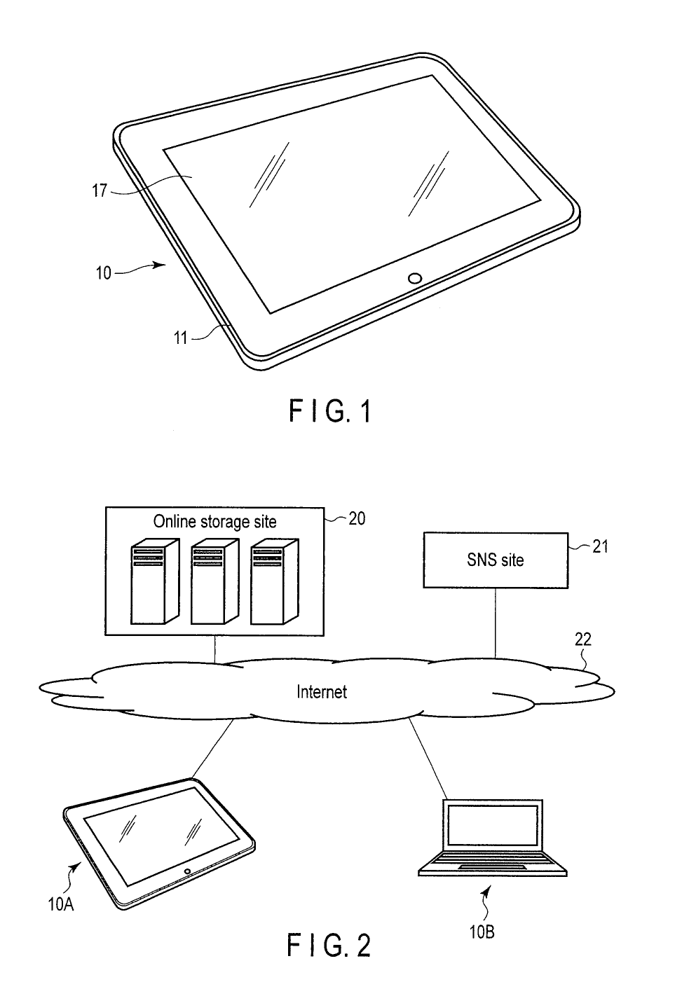

The configuration of an electronic apparatus according to one embodiment will be described below with reference to FIG. 1. The electronic apparatus of this embodiment is implemented as a portable electronic apparatus, for example, a tablet computer 10. This electronic apparatus may be implemented as a notebook type personal computer, PDA, or the like.

The tablet computer 10 is configured by a computer main body 11 and touch screen display 17. The computer main body 11 has a low profile box shaped housing. The touch screen display 17 is arranged on the surface of the computer main body 11. The touch screen display 17 includes a flat panel display (for example, a liquid crystal display device (LCD)) and touch panel. The touch panel is arranged to cover the screen of the LCD. The touch panel is configured to detect a position, touched by the finger of the user or a pen, on the touch screen display 17. This tablet computer 10 has a content playback function required to efficiently sort out contents such as photos, to allow the user to browse contents in a cheerful way, and to share contents easily.

The system configuration of this embodiment will be described below with reference to FIG. 2.

Computers 10A and 10B are connected to an online storage site 20 and SNS site 21 via the Internet 22. Each of these computers 10A and 10B has the same content playback function as that of the tablet computer 10 of this embodiment.

The computers 10A and 10B can exchange contents with the online storage site 20. The computers 10A and 10B can post contents on the SNS site 21.

Note that the computers 10A and 10B can exchange various kinds of data such as contents via the Internet. Also, the computer 10B can transmit, to the SNS site 21, a comment for a content such as a photo posted from the computer 10A to the SNS site 21. The computer 10A can also receive comments for the content posted on the SNS site 21.

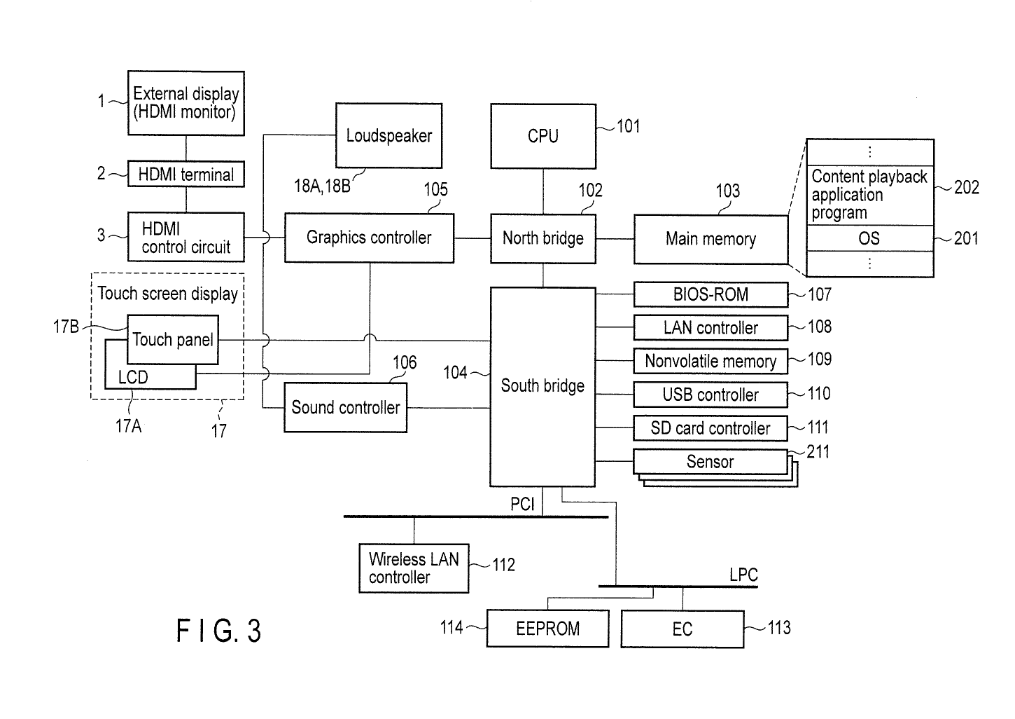

FIG. 3 shows the system configuration of the tablet computer 10.

The computer 10 includes a CPU (Central Processing Unit) 101, north bridge 102, main memory 103, south bridge 104, graphics controller 105, sound controller 106, BIOS ROM 107, LAN (Local Area Network) controller 108, nonvolatile memory 109, USB controller 110, SD card controller 111, wireless LAN controller 112, EC (Embedded Controller) 113, EEPROM (Electrically Erasable Programmable ROM) 114, sensor 211, and the like.

The CPU 101 is a processor which controls the operations of respective modules in the computer 10. The CPU 101 executes various software programs loaded from the nonvolatile memory 109 onto the main memory 103. These software programs include an OS (Operating System) 201, content playback application program 202, and the like. The content playback application program 202 is a program required to play back various contents received via the SD card controller 111, USB controller 110, or wireless LAN controller 112. The aforementioned contents include those which are received from a memory card by the SD card controller 112, those which are received from a USB memory, digital camera, or the like by the USB controller 110, those which are received from an external apparatus by the wireless LAN controller 112 via a wireless network, and the like.

The “content” is image (still image) data such as a photo, video (moving image) data, and the like. The content playback application program 202 has a function of playing back a content. The following description will be given under the assumption that a content is a photo. The content playback application program 202 is an application program, which efficiently sorts out photos, and allows the user to browse the sorted photos in a cheerful way. Also, the content playback application program 202 has a function of sharing the sorted photos with other users. The content playback application program 202 has a UI (User Interface) which allows the user to easily find out a photo, and to also find an unexpected photo.

The CPU 101 also executes a BIOS (Basic Input/Output System) stored in the BIOS ROM 107. The BIOS is a program required for hardware control.

The north bridge 102 is a bridge device which connects between a local bus of the CPU 101 and the south bridge 104. The north bridge 102 incorporates a memory controller which controls accesses to the main memory 103. The north bridge 102 has a function of executing communications with the graphics controller 105 via, for example, a PCI EXPRESS serial bus.

The GPU (graphics controller) 105 is a display controller, which controls the LCD 17 used as the display monitor of the computer 10. A display signal generated by this GPU 105 is sent to the LCD 17. Also, the GPU 105 can output a digital video signal to an external display 1 via an HDMI control circuit 3 and HDMI terminal 2.

The south bridge 104 controls respective devices on a PCI (Peripheral Component Interconnect) bus and respective devices on an LPC (Low Pin Count) bus. The south bridge 104 incorporates a nonvolatile memory controller required to control the nonvolatile memory 109. Furthermore, the south bridge 104 has a function of executing communications with the sound controller 106.

The sound controller 106 is a sound source device, and outputs audio data to be played back to loudspeakers 18A and 18B. The wireless LAN controller 112 is a wireless communication device which executes wireless communications compliant with the IEEE802.11 standard. The wireless LAN controller 112 functions as a wireless communication module which receives a content from an external apparatus via a wireless LAN.

The EC 113 is an embedded controller required for power management. The EC 113 has a function of turning on/off the power supply of the computer 10 in response to an operation of a power button by the user.

The sensor 211 can be a sensor which can detect displacements of the computer 10 (tilting, shaking, and the like of the computer 10). The sensor 211 includes, for example, an acceleration sensor, gyroscope, compass, proximity sensor, and illuminance sensor. The acceleration sensor can detect a displacement of the computer 10 based on an acceleration which changes when the main body 11 of the computer 10 has been shaken. The gyroscope can detect a displacement of the computer 10 based on a tilt of the computer 10. The compass can detect a displacement of the computer 10 based on an azimuth direction (east, west, south, north, and the like) of the computer 10. The proximity sensor can detect a displacement of the computer 10 when the computer 10 comes close to an external object. The illuminance sensor can detect a displacement of the computer 10 based on a change in illuminance. The illuminance sensor detects light (illuminance) around the computer 10. For example, when the computer 10 is a notebook type computer which includes a main body and a display pivotally attached to the main body, the illuminance sensor can be disposed on the top surface of the main body or the front surface of the display. When the display of the computer 10 is opened/closed, the illuminance sensor can detect a displacement (opening/closing of the display) of the computer 10 based on a change in light (illuminance) around the computer 10.

Note that “date and time” in the following description means “year”, “month”, “day”, “time”, “day of the week”, or the like unless otherwise specified. A date and time associated with the content is an import date of the content from a memory card or the like to the computer 10, a date and time of creation of the content, or the like. When the content is a photo, the date and time of creation of the content corresponds to a photographing date of the photo. Also, as for a date and time associated with an “SNS album” to be described later, a date and time of posting of a content on the SNS site 21 can be used.

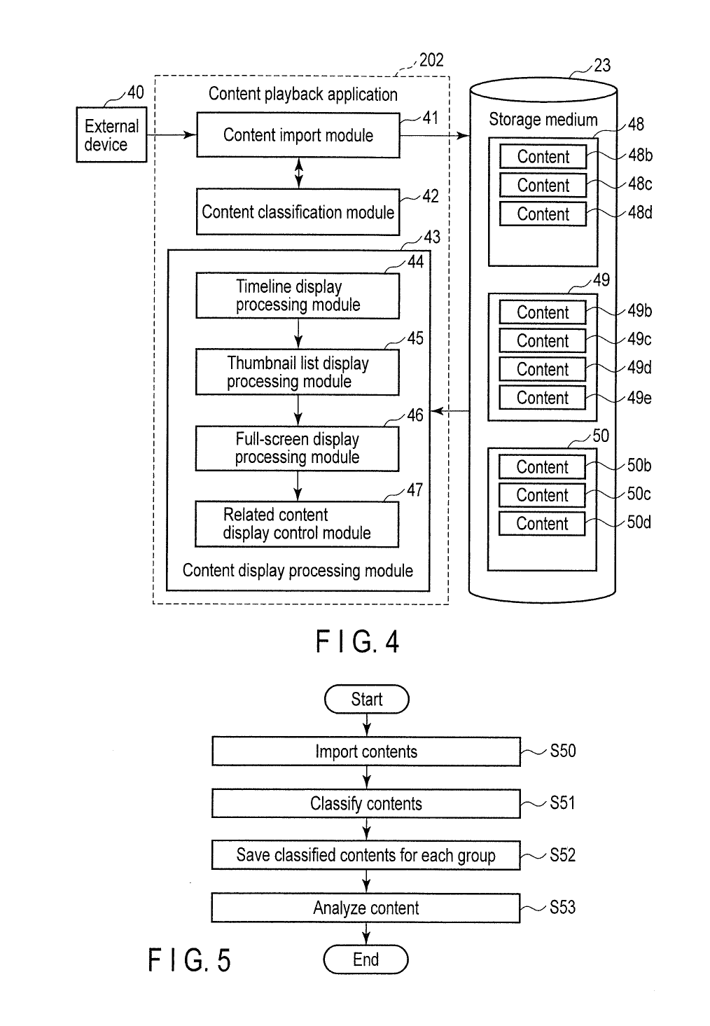

The functional configuration of the content playback application program 202 will be described below with reference to FIG. 4.

The content playback application program 202 includes a content import module 41, content classification module 42, and content display processing module 43. Functional blocks (content import module 41, content classification module 42, content display processing module 43, and the like) included in the content playback application 202 are implemented when the CPU 101 executes the content playback application 202.

The content import module 41 imports a content from an external device 40 (for example, a memory card, digital camera, or the like) to the computer 10. The content import module 41 sends the imported content to the content classification module 42 so as to classify the imported content by a predetermined classification method. The content import module 41 receives the content classified by the content classification module 42, and stores the received content in a storage medium 23.

The content classification module 42 classifies a content sent from the content import module 41 by the predetermined classification method. As the classification method of contents, for example, that for classifying contents for respective directories (folders), that for classifying contents using date and time information (for example, date and time information embedded in photos), or that for classifying contents using dates and times of posting on a cloud service such as an SNS site, and the like can be used.

Furthermore, as for classification of photos, the following classification method can also be used.

The content classification module 42 can classify contents using a clustering technique with reference to faces, smiles, or landscapes included in photos. The clustering technique uses, for example, information appended to photos. In the clustering technique using a face, a face is detected from objects, and feature amounts of the face are calculated. The feature amounts are amounts of pieces of information such as a face position, size, degree of smiling, sharpness, and frontal degree. Note that face detection and feature amount calculations (face recognition) for all photos are performed to combine photos including faces of similar features into one group. Thus, person dependent grouping can be executed. In the clustering technique using detection of a landscape (scene) of a photo, a principal object other than face is recognized from objects of a photo (scene recognition). By combining the recognized objects and face recognition results, photos can be classified based on scenes of objects. The recognizable scenes include, for example, landscapes, flowers, buildings, dishes, vehicles, and the like. By combining the scene recognition with the face recognition, family photos and group photos can be recognized. The landscapes can be further finely classified into sea, fall foliage, snow, city, Japanese style house, night scene, on the road, and the like based on their features. By adding pieces of face information or scene information recognizable by the face recognition or scene recognition to a database in the computer 10, the number of recognizable faces or scenes can be increased. Using such clustering technique, photos can be grouped based on types of their objects and the like.

A set of plural contents classified into a same group by the content classification module 42 is called a content group or album. The plural contents which belong to a same content group are associated with a certain common period. For example, when one content group is formed by plural photos which were taken during a certain trip, a period corresponding to that of this trip is associated with the plural photos. On the other hand, when plural photos imported to the computer 10 on the same day, a period corresponding to this import day is associated with the plural photos. Plural different content groups obtained by the classification processing of the content classification module 42 may be respectively stored in plural different folders on the storage medium 23.

The content display processing module 43 includes a timeline display processing module 44, thumbnail list display processing module 45, full screen display processing module 46, and related content display control module 47. The content display processing module 43 functions as a display processor configured to execute processing required to display a content stored in the storage medium 23 on the display 17.

The timeline display processing module 44 performs processing to execute a function (timeline display function) of simultaneously displaying plural content groups in a chronological order, which are classified by different classification method, on, for example, a line indicating the time axis (timeline).

The thumbnail list display processing module 45 performs processing to execute a function (list display function) of displaying a list of images respectively corresponding to contents included in a content group selected by the user from the plural content groups displayed by the timeline display function. With the list display function, plural thumbnails (a plurality of thumbnail images) corresponding to plural contents included in the selected content group are displayed.

The full screen display processing module 46 performs processing to display, on the display 17 in a full screen mode, one content corresponding to a certain thumbnail selected by the user from the plural thumbnails displayed by the list display function.

The related content display control module 47 performs processing (related content display function) to display, on the display 17, a content related to the content displayed in the full screen mode by the full screen display processing module 46. The related content display control module 47 determines based on a sensor value (detection value) sent from the sensor 211 whether or not a related content is to be selected, that is, the presence/absence of a predetermined displacement of the computer 10. When it is determined based on the detection value of the sensor 211 that the computer 10 has displaced, the related content display control module 47 selects a related content from contents stored in the storage medium 23. The related content need only be that related to the content currently displayed by the full screen display processing module 46. The related content is not limited to a content including any of the same or similar photographing date, photographing location, photographing target, included persons, creator, and the like, but it may be a content stored in another folder different from a folder which stores the currently displayed content. The related content display control module 47 sends the selected related content to the content display processing module 43. For example, it is assumed the case that the user makes a predetermined operation (he or she shakes the computer 10), and values of multiple sensors (first and second sensors) exceed thresholds. In this case, the related content display control module 47 can select a first related content using a first selection criterion corresponding to the first sensor, and a second related content using a second selection criterion corresponding to the second sensor. The related content display control module 47 can display plural different related contents on the display 17 using plural different selection criteria at the same timing.

In the storage medium 23, plural contents are stored in each of plural folders. FIG. 4 shows three folders. The three folders are folders 48, 49, and 50. The folder 48 stores three contents. The three contents in the folder 48 are contents 48b, 48c, and 48d. These contents 48b, 48c, and 48d may be those which belong to a certain same content group. Likewise, the folder 49 stores four contents. The four contents in the folder 49 are contents 49b, 49c, 49d, and 49e. These contents 49b, 49c, 49d, and 49e may be those which belong to a certain same content group. The folder 50 stores three contents. The three contents in the folder 50 are contents 50b, 50c, and 50d. These contents 50b, 50c, and 50d may be those which belong to a certain same content group.

Note that FIG. 4 shows the case in which one folder stores a plurality of contents. However, one folder can store only one content.

Also, the content import module 41 receives a content sent from the online storage site 20. For example, it is assumed the case that a content to be displayed on the display 17 is not stored in the storage medium 23, more specifically, when the computer 10 holds information (for example, metadata or the like) associated with the content, but when the content itself is stored in the online storage site 20. In this case, the content import module 41 may execute processing for importing that content from the online storage site 20, when that content is to be displayed on the display 17.

The sequence of content import processing in the content playback application 202 will be described below with reference to FIG. 5.

The content import module 41 imports contents from an external storage device which stores the contents (step S50). Note that the content import processing is automatically started in response to connection of the external storage device such as a memory card to the computer 10. The content classification module 42 classifies the imported contents to create one or more content groups (step S51). Each content group is stored in a folder corresponding to this content group on the storage medium 23 (step S52).

Next, the content playback application 202 analyzes respective contents stored in the storage medium 23 (step S53). To analyze a content is to analyze information included in a content such as a photo using the aforementioned clustering technique. By analyzing the content, for example, index information or the like of the photo can be generated. The index information can be used to decide types of photos to be displayed when photos in a user album are displayed.

Note that the content analysis processing in step S53 need not always be executed after step S52, and it may be executed before, for example, step S52 or may not be executed in the content import processing shown in FIG. 5. The processing in step S53 may be executed as, for example, background processing when the content display processing module 43 reads out a content from the storage medium 23 so as to display the content.

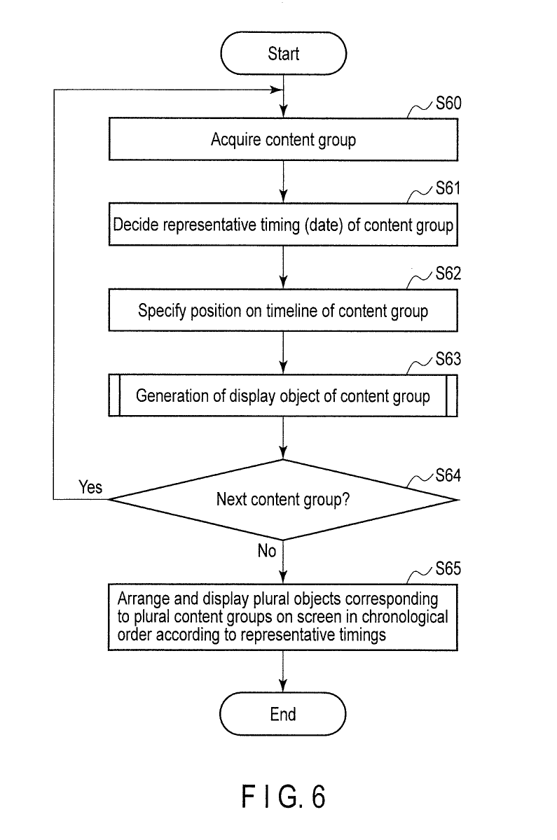

The sequence of timeline display processing of the content playback application 202 will be described below with reference to FIG. 6. As described above, the content import module 41, content classification module 42, and content display processing module 43 are implemented when the CPU 101 executes the content playback application 202.

Initially, the content import module 41 acquires one content group to be displayed on a timeline display screen (step S60). In step S60, the content import module 41 acquires, from a folder corresponding to the one content group, a plurality of contents which belong to that content group. As described above, since the plural contents belong to the same content group, the plural contents correspond to those which are associated with a certain period.

Next, the content display processing module 43 decides a timing (representative timing) corresponding to the acquired content group (step S61). The representative timing is not particularly limited as long as a timing corresponds to a content group. For example, the latest date and time of a plurality of dates and timings corresponding to a plurality of contents in a content group may be decided as a representative timing. The representative timing is the latest date and time, oldest date and time, an intermediate date and time between the oldest and latest dates and times, a date and time which most frequently appears of contents in a content group, or a period to be defined by these dates and times.

Next, the content display processing module 43 specifies a position on a timeline corresponding to the content group based on the representative timing (step S62).

The content display processing module 43 then generates an object which represents a set of the aforementioned plural contents which belong to the content group (step S63). The object may be one which allows the user to recognize that plural contents belong to the same content group. For example, a frame having a predetermined display fashion (for example, a frame having a rectangular shape, that having an oval shape, or the like), a region filled with a color different from a background color, or the like can be used. The object can include at least an image display region. The image display region is a region that can display one or more images. On an image display region in an object corresponding to a certain content group, plural images corresponding to plural contents which belong to the certain content group may be displayed. In this case, the content display processing module 43 may sequentially display the plural images corresponding to the plural contents which belong to the content group on the image display region. Thus, since an image to be displayed on the image display region are switched among the plural images corresponding to the plural contents, the display substance of the image display region is changed along with an elapse of time. In this manner, the content display processing module 43 can switch an image to be displayed on the image display region among plural images corresponding to plural contents which belong to the same content group. Thus, what kinds of contents in the content group are grouped can be plainly presented to the user.

As types of image display regions in an object, two types, that is, “photo tile” and “map tile” can be used. “Photo tile” is an image display region used to display an image such as a photo. “Map tile” is an image display region used to display a map associated with the corresponding content group.

Note that the display fashion of an object may be changed according to the classification method. Now a case will be assumed wherein plural contents which belong to a first content group are classified into the first content group by a first classification method, and plural contents which belong to a second content group are classified into the second content group by a second classification method. In this case, the content display processing module 43 generates an object having a first display fashion corresponding to the first classification method as an object corresponding to the first content group. Also, the content display processing module 43 generates an object having a second display fashion, which corresponds to the second classification method and is different from the first display fashion, as an object corresponding to the second content group. Thus, the objects having different display fashions can be displayed on a single timeline display screen. The objects having different display fashions are arranged on the timeline display screen in a chronological order. Furthermore, the content display processing module 43 can change a display fashion of an object according to an information amount (for example, the number of contents) of a corresponding content group. For example, the content display processing module 43 can change the number of image display regions displayed within an object according to the number of contents included in a corresponding content group, and can change a size of the object according to the number of image display regions.

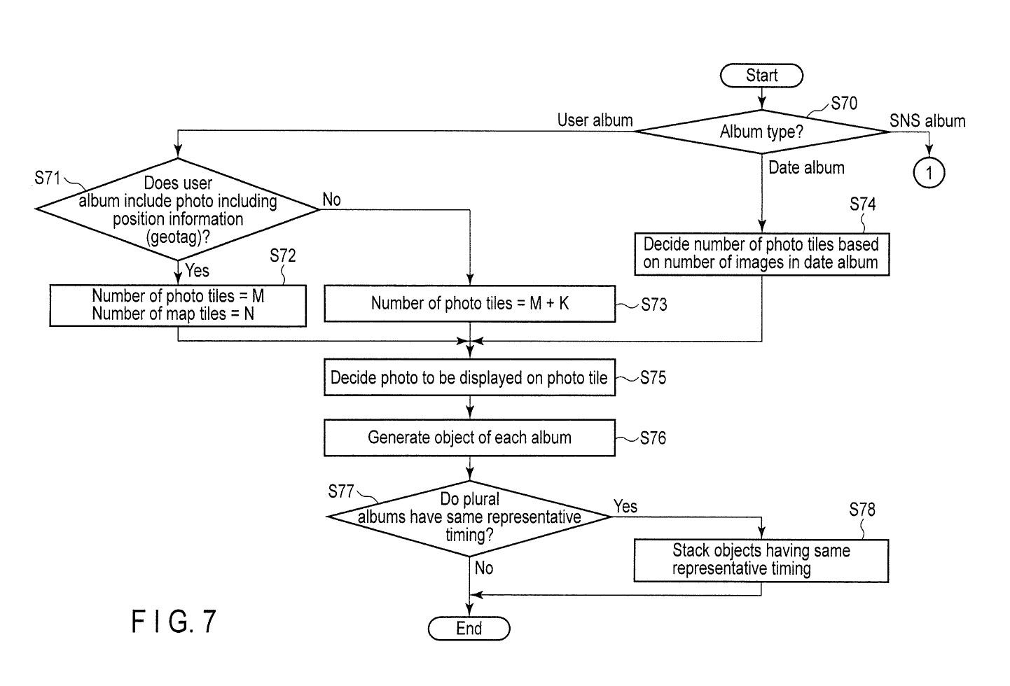

Detailed processing of step S63 will be described later with reference to FIG. 7.

Next, the content import module 41 determines whether or not content groups to be displayed on the timeline display screen still remain (step S64). If content groups to be displayed on the timeline display screen still remain (YES in step S64), the process returns to step S60, and the content import module 41 acquires a content group again. If content group to be displayed on the timeline display screen does not remain (NO in step S64), the content display processing module 43 displays plural objects respectively corresponding to plural content groups side by side in one direction in a chronological order on the timeline display screen (step S65). The plural objects are displayed while being arranged along one direction in descending order of, for example, the corresponding period. The display positions of the plural objects respectively corresponding to the plural content groups on the timeline display screen can be specified by representative timings corresponding to the plural content groups. Now a case will be assumed wherein a first object corresponding to a first content group associated with a first period, and a second object corresponding to a second content group associated with a second period are to be displayed. On the timeline display screen, the timeline which represents the time axis is displayed, as described above. The content display processing module 43 displays the aforementioned first object in associated with a position on the timeline, which position corresponds to a certain timing in the aforementioned first period. As the certain timing in the first period, a representative timing corresponding to the first content group can be used. Furthermore, the content display processing module 43 displays the aforementioned second object in associated with a position on the timeline, which position corresponds to a certain timing in the aforementioned second period. As the certain timing in the second period, a representative timing corresponding to the second content group can be used.

Note that in the processing shown in FIG. 6, the content display processing module 43 executes the processes of steps S60 to S64 for each content group required to be displayed on the timeline display screen, and then displays the content groups. For example, the content display processing module 43 may execute the process of step S65 before that of step S64. In such case, when plural content groups are required to be displayed, the respective content groups are displayed on the timeline display screen in turn, but the plural content groups need only be displayed at predetermined timings.

Details of the processing for generating an object of a content group in the timeline display processing of the content playback application 202 will be described below with reference to FIG. 7. In this embodiment, as types of content groups, a user album, date album, and SNS album can be used. These albums of the three types, that is, the user album, date album, and SNS album are content groups of three types, which are classified by the three classification methods which are different from each other.

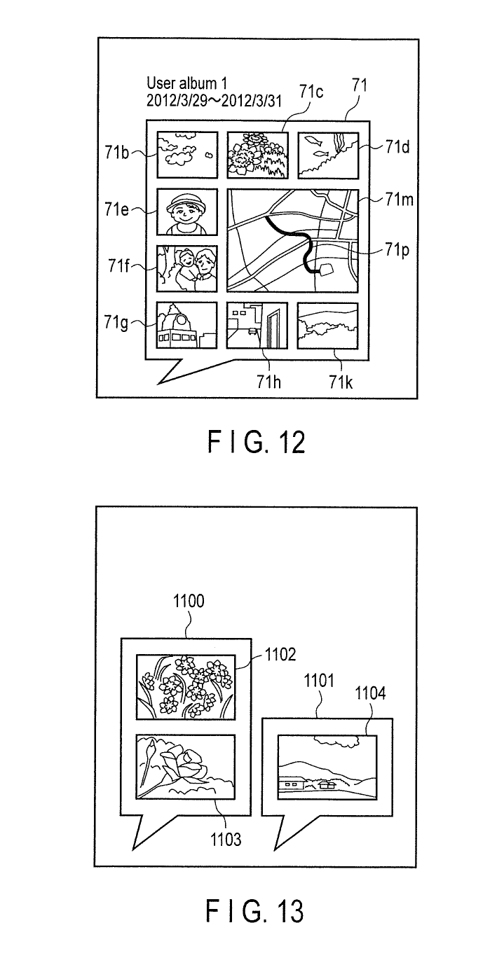

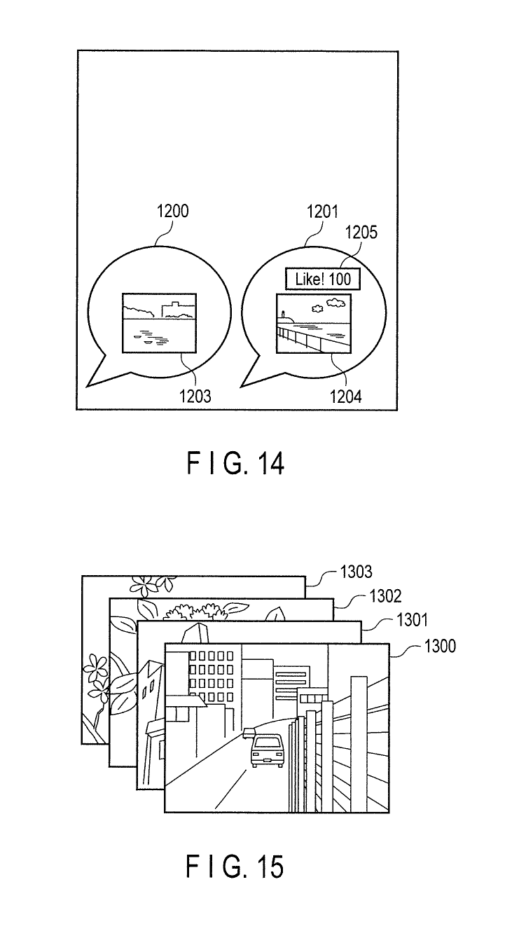

The user album includes a set of specific contents selected by the user. The date album includes a set of contents at a predetermined date. The SNS album includes a set of contents posted on the SNS site 21. Note that the user album, date album, and SNS album will be described in detail later with reference to FIG. 12, FIG. 13 and FIG. 14. The following description will be given under the assumption that a content group is an album including photos (images). However, a content is not limited to a photo (image), and may be the aforementioned content.

Since an object display fashion is different for each album type, the timeline display processing module 44 determines an album type first (step S70). If the album is a user album, the timeline display processing module 44 determines whether or not the user album includes a photo having position information (geotag) (step S71). If the user album includes a photo including position information, the timeline display processing module 44 decides the number of photo tiles to be laid out in an object corresponding to the user album to be M (for example, 8) (step S72). And the timeline display processing module 44 also decides the number of map tiles to be laid out in this object to be N (for example, 1) (step S72). If the user album does not include any photo having position information, the timeline display processing module 44 decides the number of photo tiles to be laid out in the object corresponding to the user album to be M+K (for example, 12 (=8+4)) (step S73). And the timeline display processing module 44 also decides the number of map tiles to be laid out in this object to be 0 (step S73). That is, it is decided that K photo tiles are to be laid out in the object in place of one map tile.

If the determination result in step S70 indicates a date album, the timeline display processing module 44 decides the number of photo tiles to be laid out in an object corresponding to the date album based on the number of photos in the date album (step S74). For example, if the number of photos in the date album is less than 10, the timeline display processing module 44 decides the number of photo tiles to be laid out in the object corresponding to the date album to be 1. If the number of photos in the date album is, for example, 10 or more but 20 or less, the timeline display processing module 44 decides the number of photo tiles to be laid out in the object corresponding to the date album to be 2. On the other hand, if the number of photos in the date album is, for example, 30 or more, the timeline display processing module 44 decides the number of photo tiles to be laid out in the object corresponding to the date album to be 3.

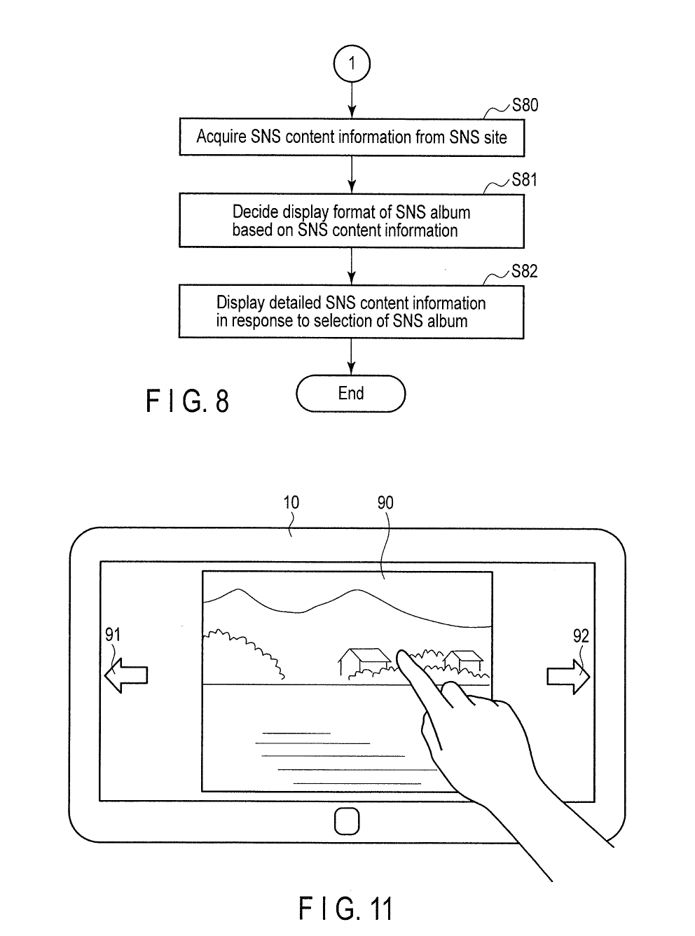

Note that details of the case in which the determination result in step S70 indicates an SNS album will be described later with reference to FIG. 8.

After the process of any of steps S72, S73, and S74, the timeline display processing module 44 decides photos to be displayed on each photo tile (step S75). For example, as for the date album including 10 to 20 photos, the timeline display processing module 44 selects about 10 photos in the date album as those to be displayed on one of the two photo tiles, and selects about 10 remaining photos in the date album as those to be displayed on the other photo tile.

Next, the timeline display processing module 44 generates an object corresponding to each album (step S76). Then, the timeline display processing module 44 determines whether or not plural albums have the same representative timing (step S77). If the plural albums have the same representative timing (YES in step S77), the timeline display processing module 44 stacks objects corresponding to these albums, and displays them on the timeline display screen (step S78). In this manner, by stacking the objects corresponding to albums have the same representative timing, the user can intuitively recognize that contents in the albums were acquired (for example, captured) during the same period.

Note that the user can change the display fashion of the object corresponding to each album. Also, the size of the object may be changed according to, for example, the number of photo tiles included in that object.

Details of the processing for generating an object corresponding to an SNS album in the timeline display processing of the content playback application 202 will be described below with reference to FIG. 8.

If an SNS album is determined in step S70, the timeline display processing module 44 acquires an SNS content from the SNS site 21 (step S80). The SNS content can be that which can be posted onto the SNS site, and includes, for example, an evaluation for a content (photo) posted on the SNS site 21, a comment for a posted content (photo), a date of posting of a comment, and the like.

Next, the timeline display processing module 44 decides a display fashion of an object corresponding to the SNS album based on the SNS content (step S81). The display fashion of the object corresponding to the SNS album is changed based on the SNS content. For example, as will be described in detail later with reference to FIG. 14, when a posted photo gains a high evaluation, the size of the object of the SNS album is increased.

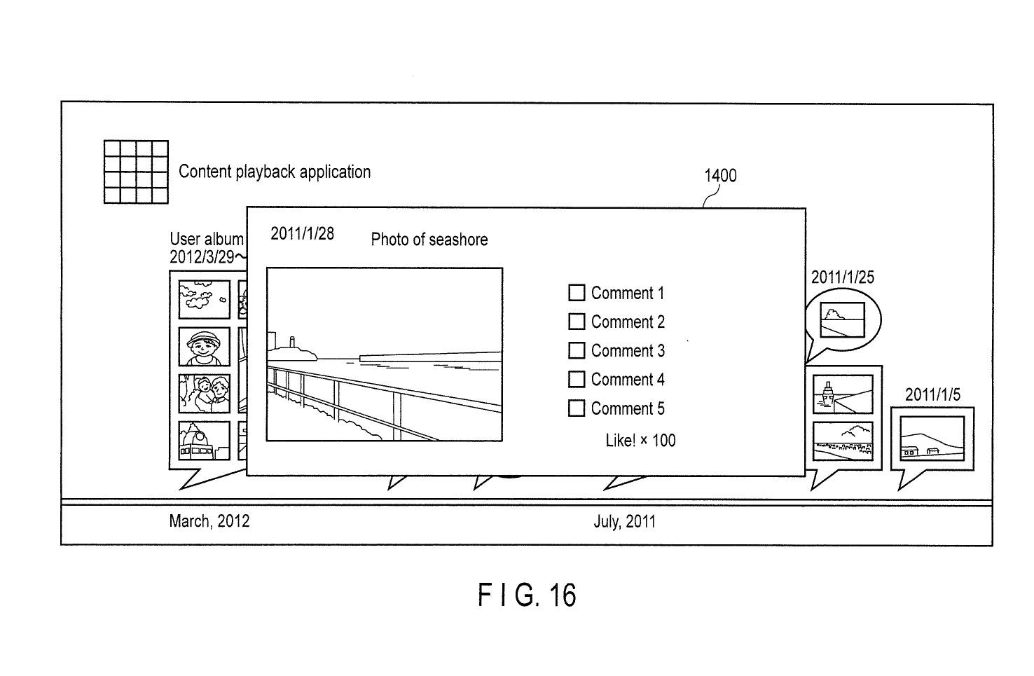

After that, when the object corresponding to the SNS album is selected by a user operation (for example, clicking), the timeline display processing module 44 displays an SNS detailed screen shown in FIG. 16, as will be described later with reference to FIG. 16 (step S82).

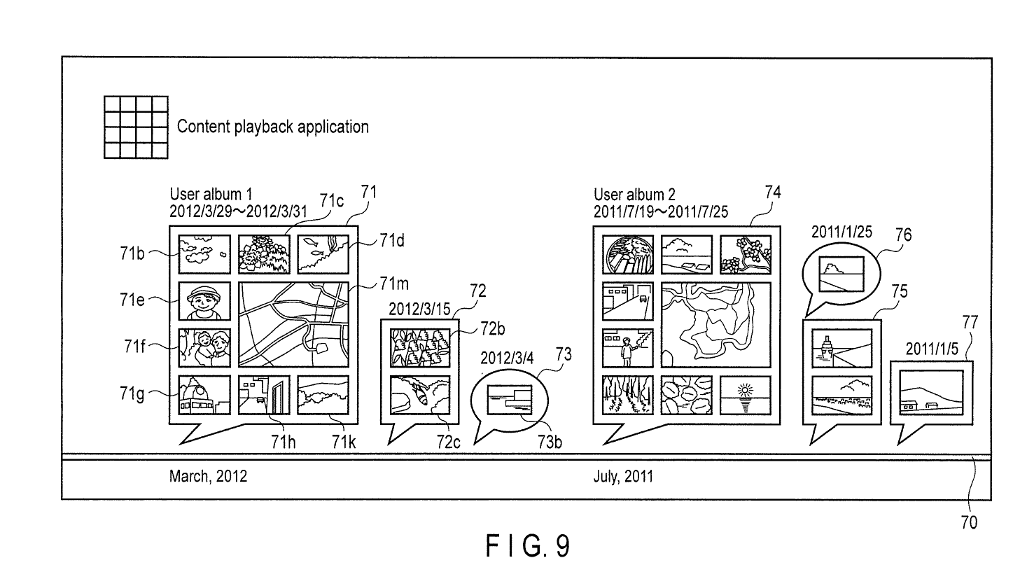

An example of the timeline display screen displayed by the content playback application program 202 will be described below with reference to FIG. 9.

The timeline display screen is an initial screen when the content playback application 202 is launched, and is also a screen serving as a starting point to respective display modes of a thumbnail list display screen, full display screen, and the like (to be described later). The timeline display screen is used to display plural objects corresponding to plural albums along the time axis. A timeline 70 which is displayed on the lower portion of the timeline display screen represents the time axis, and objects corresponding to respective albums are displayed as frames, for example, a balloon. Also, below the timeline 70, labels each of which displays “year” and “month” are laid out. The user can browse objects corresponding to respective albums by going back time from the left side to the right side in FIG. 9. By scrolling the timeline display screen to the right side, objects of older albums are displayed. Note that the timeline 70 shown in FIG. 9 may not be displayed. When the time axis is not displayed, objects corresponding to albums may be displayed to be arranged in a chronological order with respect to a predetermined direction.

On the timeline display screen, an object corresponding to each album is displayed in the display fashion such as a balloon, as described above. One or more photo tiles are displayed inside the object corresponding to each album. On photo tiles, plural thumbnails corresponding to plural photos included in the same album are displayed while being switched in turn (slideshow). Thus, photos included in each album can be presented to the user.

More specifically, in FIG. 9, seven objects 71 to 77 are arranged in a chronological order. The object 71 represents a user album 1, the object 72 represents a date album, the object 73 represents an SNS album, and the object 74 represents a user album 2. Furthermore, the object 75 represents another date album, the object 76 represents another SNS album, and the object 77 represents still another date album.

The object 71 of the user album 1 includes eight small photo tiles 71b to 71k, and one large map tile 71m.

The object 71 of the user album 1 is displayed in associated with a position on the timeline 70. This position on the timeline 70 corresponds to a representative timing of the user album 1. More specifically, the object 71 of the user album 1 is a rectangular frame having a triangular projection, and the object 71 is displayed so that the triangular projection points to a position “March, 2012” on the timeline 70 as the representative timing of the user album 1. Also, “user album 1” as a title of the user album 1, and a photographing period corresponding to plural photos in the user album 1 are displayed above the object 71.

The period displayed above the object 71 of the user album 1 indicates that between the latest date and the oldest date of photographing dates corresponding to the photos included in the user album 1. Note that this period includes the aforementioned representative timing. In FIG. 9, the period of the user album 1 is displayed like “2012/3/29 to 2012/3/31”. In this manner, the timeline display processing module 44 groups photos taken during a predetermined period, and displays them as a photo group corresponding to one representative point in place of simply arranging plural photos taken on different dates in a chronological order.

As for the date album, the object 72 of the date album is displayed in associated with a position on the timeline 70. This position on the timeline 70 corresponds to a representative timing of this date album. More specifically, the object 72 of the date album is a rectangular frame having a triangular projection, and the object 72 is displayed so that the triangular projection points to the position of the timeline 70 corresponding to the representative timing of the date album. The object 72 includes two photo tiles 72b and 72c.

As for the SNS album, the display object 73 of the SNS album is displayed in associated with a position on the timeline 70. This position on the timeline 70 corresponds a representative timing of this SNS album. More specifically, the display object 73 of the SNS album is an oval frame having a triangular projection, and the object 73 is displayed so that the triangular projection points to the position on the timeline 70 corresponding to the representative timing of the SNS album. The object 73 includes one photo tile 73b.

When a representative date corresponding to a certain date album is the same as that corresponding to a certain SNS album, the object 75 corresponding to that date album and the object 76 corresponding to that SNS album are displayed while being stacked at the same position on the timeline 70, as shown in FIG. 9.

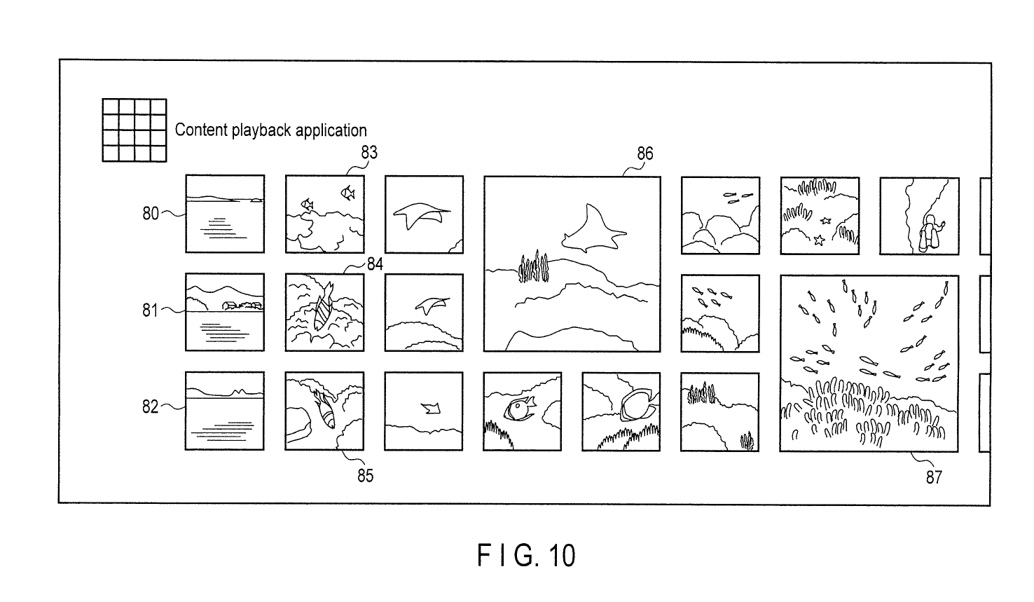

An example of the thumbnail list display screen will be described below with reference to FIG. 10. Note that the display 17 will also be referred to as a screen hereinafter.

FIG. 10 shows the thumbnail list display screen. The thumbnail list display screen displays a list of thumbnails of plural photos in an album corresponding to an object selected from plural objects displayed on the timeline display screen shown in FIG. 9. For example, when the user selects the object 71 on the timeline display screen shown in FIG. 9, plural thumbnails corresponding to plural photos in the user album 1 corresponding to the object 71 are displayed on the thumbnail list display screen. On the thumbnail list display screen shown in FIG. 10, thumbnails are arranged in turn from an upper left corner and from one having the latest photographing date (photographing date and time) of a photo. For example, a thumbnail 80 corresponds to a photo having a later photographing date than those of photos corresponding to thumbnails 81, 83. The thumbnail 81 corresponds to a photo having the photographing date of which is later than the photo corresponding to the thumbnail 82. Note that either of the photographing date of a photo corresponding to the thumbnail 82 or that of a photo corresponding to the thumbnail 83 may be later.

Some of thumbnails are displayed to have a size for four thumbnails, and photos in the same album are displayed in a slideshow mode. Thumbnails 86 and 87 are those having a size for four thumbnails.

By selecting a thumbnail or a thumbnail on which a slideshow is displayed by, for example, clicking, a photo corresponding to the selected thumbnail can be displayed in a full screen mode, as shown in FIG. 11. Note that by making, for example, a pinch out operation on the touch panel 17B in place of clicking on the thumbnail, a photo corresponding to the selected thumbnail is displayed in the full screen mode. In this case, a photo corresponding to a thumbnail near the central point where the pinch out operation is made is displayed in the full screen mode.

Note that a slideshow may be made for the thumbnails 80 to 85 other than the thumbnails 86 and 87. The user may set a time interval, effect, and the like of the slideshow. Also, the size of each thumbnail and the number of rows of thumbnails may be changed according to the resolution of the screen. For example, FIG. 10 shows a case in which the number of rows of thumbnails is 3. Furthermore, in order to allow the user to recognize an album including the photos displayed on the thumbnail list display screen, an album title may be displayed by assuring, for example, an album title display region.

In place of an album displayed on the timeline display screen, for example, photos at a specific date on a calendar may be displayed in a list using a calendar function included in the content playback application 202. Furthermore, photos taken at a specific location displayed on a map displayed on the timeline display screen may be displayed as a list.

An overview of a full screen display operation in the content playback application 202 will be described below with reference to FIG. 11.

The content playback application 202 displays a photo corresponding to a thumbnail selected on the thumbnail list display screen shown in FIG. 10 in a full screen mode (full screen display). The full screen display means to display an image of a photo in an enlarged scale. Note that the full screen display is to display the entire photo on the screen as large as possible. In this case, the entire photo need not always be displayed, and a portion of the enlarged photo may be displayed on the screen to have a large size.

When the user flicks or makes a keyboard or mouse operation in a direction (right and left direction) denoted by reference numeral 91 or 92, a photo to be displayed in the full screen mode can be switched to that in the same folder before or after a photo 90 which is currently displayed in the full screen mode. That is, a photo to be displayed in the full screen mode can be switched to a photo before or after the photo 90 in the same album (the same content group) as the photo 90. Note that FIG. 11 shows the full display screen when the thumbnail 81 in FIG. 10 is selected.

When the user flicks in the direction 92, the content playback application 202 switches the photo 90 to that having an older date than that of the photo 90, and displays that photo in the full screen mode. When the user flicks in the direction 91, the content playback application 202 switches the photo 90 to that having a later date than that of the photo 90, and displays that photo in the full screen mode.

When the user makes, for example, a mouse operation, mouse switching buttons used to switch a photo are displayed on the two ends on the screen. When the user selects the mouse switching button by operating a mouse, the photo 90, which is currently displayed in the full screen mode, can be switched to that in the same folder before or after the photo 90. Note that a photo before or after the currently displayed photo in the same folder is that displayed on the thumbnail list display screen shown in FIG. 10. The direction to flick is not limited to the right and left direction, but it may be, for example, a direction (up and down direction) perpendicular to the right and left direction.

The user album on the timeline display screen will be described below with reference to FIG. 12. The object 71 of the user album includes photo tiles 71b to 71h, a photo tile 71k, and a map tile 71m. The number of photo tiles in the user album 71, types of photo tiles in the user album 71, or a layout of the photo tiles and map tile in the user album 71 can be set in advance to have a layout including, for example, eight small photo tiles and one large map tile, as shown in FIG. 12. However, the user may change the number of photo tiles and that of map tiles, or the layout of the photo tiles and map tile. The photo tiles of the user album can be set to display different reference photos. For example, the photo tile 71e can be set to display a photo including one person, and the photo tile 71f can be set to display a photo including a smiling person or two persons. The map tile 71m can be displayed when capturing locations of photos in the user album are known. On the map 71m, photographing locations of some photos in the user album can be indicated by a locus 71p.

Also, the photo tiles in the object corresponding to the user album may be randomly laid out. When any face, smile, or landscape is not detected from photos in the user album, a photo tile corresponding to a face, smile, or landscape, which is not detected, may not be laid out in the object. Also, a photo tile which displays a face, smile, or landscape (a photo without any face) detected from photos in the user album can be displayed.

The date album on the timeline display screen will be described below with reference to FIG. 13. The number of photo tiles displayed within the object corresponding to the date album is determined based on the number of photos (images) saved in the date album, as described above. For example, a predetermined number of photos, for example, 10 photos, are displayed in turn on one photo tile. In this case, the number of photo tiles is increased by one for 10 photos. On the other hand, the number of photo tiles displayed within the object corresponding to the date album may be set not to exceed a predetermined value. A size of an object 1100 including photo tiles 1102 and 1103 is set to be larger than that of a display object 1101 including a photo tile 1104.

The SNS album on the timeline display screen will be described below with reference to FIG. 14. Each of objects 1200 and 1201 corresponding to SNS albums is displayed to have an oval frame different from the user album or date album. In the object of the SNS album, a photo posted on the SNS site 21 is displayed on a photo tile 1203 or 1204. On the SNS album, an evaluation for the posted photo can also be displayed, as indicated by SNS album information 1205 ([Like! 100]) in FIG. 14. For example, when an evaluation value indicated by the SNS album information 1205 is high, an object color may be changed or an object may be displayed in an enlarged scale.

Note that a slideshow can also be displayed on each photo tile of each object of the user album, date album, or SNS album.

The slideshow on the thumbnail list display screen will be described below with reference to FIG. 15.

The slideshow displays photos in the same album in turn while changing a photo to be displayed along with an elapse of time. The slideshow can display photos 1300 to 1303 to overlap each other while being shifted little by little, as shown in FIG. 15. On the user album and date album, related photos may be displayed in the slideshow mode using metadata of photos or results of a clustering technique. In case of the SNS album, photos posted on the SNS site 21 on the same day may be displayed in the slideshow mode.

A display example of the SNS album detailed information screen displayed when, for example, an object corresponding to the SNS album is selected on the timeline display screen will be described below with reference to FIG. 16.

On an SNS album detailed information screen 1400, a posted photo, date of posting, a name of the posted photo, a comment for the posted photo, an evaluation for the posted photo, and the like, are displayed. As for the comment for the posted photo, when plural comments are posted, a predetermined number of comments (five comments in FIG. 16) can be set to be displayed.

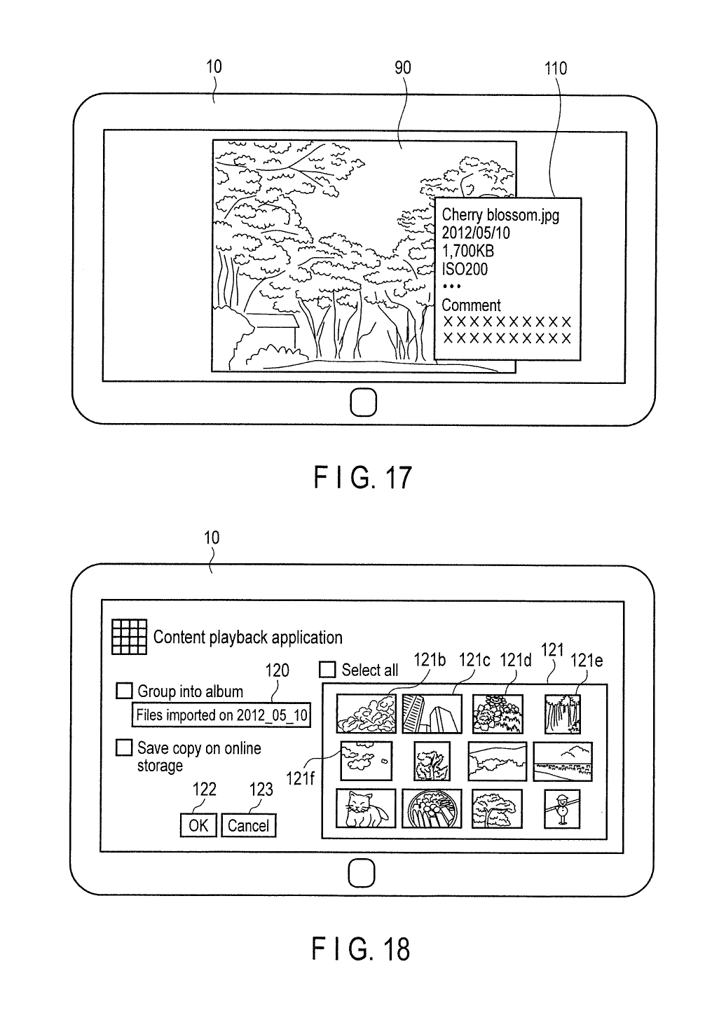

A display example of information of a currently browsed photo will be described below with reference to FIG. 17.

For example, when the user selects the photo 90, which is currently displayed in the full screen mode, by, for example, clicking, a photo detailed information screen 110 shown in FIG. 17 is displayed. The photo detailed information screen 110 displays a file name “cherry blossom.jpg” of the photo 90, a date “2012/05/10” of the photo 90, a file size “1,700 KB” of the photo 90, a comment associated with the photo 90 input by the user or the like, and so forth.

An example of a screen displayed upon importing a photo will be described below with reference to FIG. 18.

A case will be assumed wherein an external device is connected to the computer 10, and the connected external device is presented by the OS 201. In such case, when the user selects the content playback application 202 from a list used to select an application to be launched for the connected external device, an “import from external device” screen is displayed, as shown in FIG. 18.

On the “import from external device” screen, photo (image) files detected from the external device are displayed as a list, and all the detected photos (images) or some photos (images) selected from the detected photos can be imported to a photo folder. The photo folder is that used to save photos (images).

Upon importing photos, by checking a check box “group into album”, a user album can be created. When the check box “group into album” is not checked, photos selected from those which can be imported are classified based on their dates, and classified photos are stored in a date album.

Upon creating the user album, an album name is input to a text box 120 below the check box “group into album”. A predetermined album name displayed in the text box 120 is that created based on a date of import. The user can change this predetermined album name to an arbitrary album name, and can create a user album.

Also, photos to be imported can be uploaded to the online storage site 20. By checking a check box “save copy on online storage” in FIG. 18, photos can be imported from the external device to the photo folder, and the imported photos can be saved on an online storage of the online storage site 20. Note that when the imported photos are saved in the computer 10 as a user album, that user album is also uploaded to the online storage site 20. A user album name to be uploaded may be that of a user album to be saved in the computer 10, but it may be changed to a name which allows the user to recognize that the user album is uploaded to the online storage site 20. Likewise, when the imported photos are saved in the computer 10 as a date album, that date album is also uploaded to the online storage site 20. Photos in a photo folder to be uploaded to the online storage site 20 correspond to those in the photo folder saved in the computer 10.

When the user clicks an “OK” button 122 on the screen of FIG. 18, photos begin to be imported. On the other hand, if the user clicks a “Cancel” button, the screen transits from the “import from external device” screen to the timeline display screen without importing a photo.

Also, an import photo selection box 121 displays thumbnail images 121b to 121f and the like. By checking a check box corresponding to “select all” in FIG. 18, photos to be saved in the photo folder can be selected from the import photo selection box. Note that in FIG. 18, the import photo selection box 121 displays plural thumbnail images, but it may display only one thumbnail image. When the check box corresponding to “select all” is not checked, photos which can be imported by the content playback application 202 when the external device is connected to the computer 10 (for example, photos corresponding to thumbnail images that can be displayed on the import photo selection box 121) are saved in the photo folder.

Note that after photos to be imported are decided on the screen shown in FIG. 18, an import screen indicating the progress of import processing or the like may be displayed during a period in which data of the photos to be imported are sent from the external device to the computer 10. When the import screen is displayed, for example, a button used to abort the import processing may be displayed on that screen. When the import processing is aborted, photos which have been imported before the abort timing are saved in the photo folder. Upon completion of the import processing of photos, a list of imported photos may be displayed on the thumbnail list screen shown in FIG. 10.

Arbitrary photos saved in folders other than the photo folder can be imported to the photo folder. A file selection dialog box or the like may be displayed to allow the user to select photos (image files) in an image file fashion in a folder other than the photo folder. Note that when selected image files are those included in a folder other than the photo folder, the selected image files may be copied to the photo folder. Note that when image files included in a folder other than the photo folder are to be imported, a button used to call an image file selection dialog box may be displayed, and thumbnails of the selected image files may be displayed as a list.

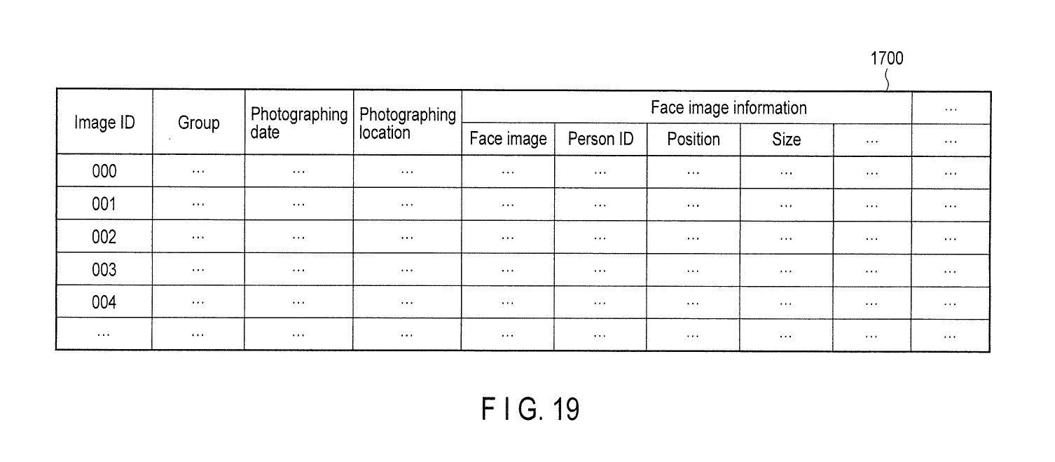

An example of a photo (image) index information database table will be described below with reference to FIG. 19.

FIG. 19 shows an example of an index information database table which configures an index information database 1700. The index information database table 1700 includes plural entries corresponding to plural still images. Each entry includes fields corresponding to, for example, “image ID”, “group”, “photographing date”, “photographing location”, and “face image information”. In an entry corresponding to a certain still image, “image ID” indicates identification information unique to that still image. “Group” indicates a name of a group (content group) having the still image. “Photographing date” indicates a date on which that still image was taken. “Photographing location” indicates a location where the still image was taken or that where the still image was acquired. Note that the information of “photographing location” includes that such as a latitude or longitude of a photographing spot measured by GPS (Global Positioning System).

Note that “photographing date”, “photographing location”, and the like of the index information database 1700 are appended to a photo as metadata of that photo such as Exif (Exchangeable image file format). The Exif includes a type of a camera used in photographing, a type of a lens used by that camera, photographing conditions, or the like. In addition, the Exif includes information such as a latitude and longitude of the photographing site measured by GPS. “Face image information” in the index information database 1700 includes fields “face image”, “person ID”, “position”, “size”, and the like, which can be obtained by executing the aforementioned clustering processing associated with a face.

As described above, according to this embodiment, a first object which represents a set of first contents associated with a first period, and a second object which represents a set of second contents associated with a second period are displayed on a screen in a chronological order in one direction according to the first and second periods. Therefore, plural contents can be presented to the user in a plain fashion. For example, when a large number of photos are sorted out, and the sorted photos are to be browsed, the large number of photos to be imported to the computer 10 are classified into plural groups, and the plural classified groups can be simultaneously displayed on the screen in a chronological order. For this reason, the user can easily select a photo. Also, the user can easily obtain information associated with a photo. By changing a display fashion of a group in accordance with the number of photos in that group, the user can intuitively obtain desired information.

All of the sequences of the processes described in this embodiment can be implemented by software. For this reason, by installing a computer program required to implement the sequence of the processes in a normal computer via a computer readable storage medium that stores the program, and executing the installed program, the same effects as those in this embodiment can be easily realized.

The functions of the respective modules shown in FIG. 4 may be implemented by, for example, hardware such as a dedicated LSI or DSP.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processor configured to acquire a plurality of first contents associated with a first period, and a plurality of second contents associated with a second period different from the first period; and
a display processor configured to display on a screen a first object representing a set of the plurality of first contents and a second object representing a set of the plurality of second contents on the screen in accordance with the first period and the second period, wherein the first object and the second object are arranged in one direction on the screen in a chronological order.

2. The apparatus of claim 1, wherein the first object comprises at least a first region for displaying one or more images, and the second object comprises at least a second region for displaying one or more images, and
the display processor is further configured to switch an image to be displayed on the first region among a plurality of images corresponding to the plurality of first contents, and switch an image to be displayed on the second region among a plurality of images corresponding to the plurality of second contents.

3. The apparatus of claim 1, wherein the display processor is further configured to display information regarding the first period in association with the first object, and display information regarding the second period in association with the second object.

4. The apparatus of claim 1, wherein the display processor is further configured to display a line which represents a time axis on the screen, display the first object in association with a position on the line corresponding to a timing in the first period, and display the second object in association with a position on the line corresponding to a timing in the second period.

5. The apparatus of claim 1, wherein the first contents comprises contents which are classified into a first single group by a first classification method, and the second contents comprises contents which are classified into a second single group by a second classification method different from the first classification method, and
the display processor is further configured to display the first object in a first display fashion corresponding to the first classification method, and display the second object in a second display fashion which corresponds to the second classification method and is different from the first display fashion.

6. The apparatus of claim 1, wherein the display processor is further configured to change display fashion of the first object in accordance with information amount corresponding to the plurality of first contents, and change display fashion of the second object in accordance with information amount corresponding to the plurality of second contents.

7. The apparatus of claim 1, wherein the display processor is further configured to display a list of a plurality of images corresponding to the plurality of first contents on the screen when the first object is selected, and display a list of a plurality of images corresponding to the plurality of second contents on the screen when the second object is selected.

8. A display control method comprising:
acquiring a plurality of first contents associated with a first period, and a plurality of second contents associated with a second period different from the first period; and
displaying on a screen a first object representing a set of the plurality of first contents and a second object representing a set of the plurality of second contents on the screen in accordance with the first period and the second period, wherein the first object and the second object are arranged in one direction on the screen in a chronological order.

9. The method of claim 8, wherein the first object comprises at least a first region for displaying one or more images, and the second object comprises at least a second region for displaying one or more images, and
the displaying comprises switching an image to be displayed on the first region among a plurality of images corresponding to the plurality of first contents, and switching an image to be displayed on the second region among a plurality of images corresponding to the plurality of second contents.

10. The method of claim 8, wherein the displaying comprises displaying information regarding the first period in association with the first object, and displaying information regarding the second period in association with the second object.

11. The method of claim 8, wherein the displaying comprises displaying a line which represents a time axis on the screen, display the first object in association with a position on the line corresponding to a timing in the first period, and displaying the second object in association with a position on the line corresponding to a timing in the second period.

12. The method of claim 8, wherein the first contents comprises contents which are classified into a first single group by a first classification method, and the second contents comprises contents which are classified into a second single group by a second classification method different from the first classification method, and
the displaying comprises displaying the first object in a first display fashion corresponding to the first classification method, and displaying the second object in a second display fashion which corresponds to the second classification method and is different from the first display fashion.

13. The method of claim 8, wherein the displaying comprises changing display fashion of the first object in accordance with information amount corresponding to the plurality of first contents, and changing display fashion of the second object in accordance with information amount corresponding to the plurality of second contents.

14. The method of claim 8, wherein the displaying comprises displaying a list of a plurality of images corresponding to the plurality of first contents on the screen when the first object is selected, and displaying a list of a plurality of images corresponding to the plurality of second contents on the screen when the second object is selected.

15. A computer-readable, non-transitory storage medium having stored thereon a computer program which is executable by a computer, the computer program controlling the computer to execute functions of:
acquiring a plurality of first contents associated with a first period, and a plurality of second contents associated with a second period different from the first period; and
displaying on a screen a first object representing a set of the plurality of first contents and a second object representing a set of the plurality of second contents on the screen in accordance with the first period and the second period, wherein the first object and the second object are arranged in one direction on the screen in a chronological order.

16. The medium of claim 15, wherein the first object comprises at least a first region for displaying one or more images, and the second object comprises at least a second region for displaying one or more images, and
the displaying comprises switching an image to be displayed on the first region among a plurality of images corresponding to the plurality of first contents, and switching an image to be displayed on the second region among a plurality of images corresponding to the plurality of second contents.

17. The medium of claim 15, wherein the displaying comprises displaying information regarding the first period in association with the first object, and displaying information regarding the second period in association with the second object.

18. The medium of claim 15, wherein the displaying comprises displaying a line which represents a time axis on the screen, display the first object in association with a position on the line corresponding to a timing in the first period, and displaying the second object in association with a position on the line corresponding to a timing in the second period.

19. The medium of claim 15, wherein the first contents comprises contents which are classified into a first single group by a first classification method, and the second contents comprises contents which are classified into a second single group by a second classification method different from the first classification method, and
the displaying comprises displaying the first object in a first display fashion corresponding to the first classification method, and displaying the second object in a second display fashion which corresponds to the second classification method and is different from the first display fashion.

20. The medium of claim 15, wherein the displaying comprises changing display fashion of the first object in accordance with information amount corresponding to the plurality of first contents, and changing display fashion of the second object in accordance with information amount corresponding to the plurality of second contents.

21. The medium of claim 15, wherein the displaying comprises displaying a list of a plurality of images corresponding to the plurality of first contents on the screen when the first object is selected, and displaying a list of a plurality of images corresponding to the plurality of second contents on the screen when the second object is selected.
